(19) United States
(12) Patent Application Publication
(10) Pub. No.: US 2022/0043795 A1
(43) Pub. Date: Feb. 10, 2022

(54) INFORMATION PROCESSING APPARATUS AND DATA PROCESSING METHOD

(71) Applicant: FUJITSU LIMITED, Kawasaki-shi (JP)

(72) Inventor: Takuto TSUJI, Kawasaki (JP)

(73) Assignee: FUJITSU LIMITED, Kawasaki-shi (JP)

(21) Appl. No.: 17/307,207

(22) Filed: May 4, 2021

(30) Foreign Application Priority Data
Aug. 5, 2020 (JP) 2020-132957

(51) Int. Cl. G06F 16/22; G06F 16/245; G06F 16/25

(52) U.S. Cl. CPC G06F 16/2282; G06F 8/30; G06F 16/258; G06F 16/245

(57) ABSTRACT

A non-transitory computer-readable recording medium has stored therein a program that causes a computer to execute a process, the process including generating token information that indicates a characteristic of an associating relation between input data and output data obtained by converting the input data according to a predetermined rule, and when searching for one or more intermediate programs used to generate a conversion program for converting the input data into the output data among multiple intermediate programs stored in a storage, excluding an intermediate program that does not correspond to the token information from candidates of the one or more intermediate programs.

### CROSS-REFERENCE TO RELATED APPLICATION

This application is based upon and claims the benefit of priority of the prior Japanese Patent Application No. 2020-132957, filed on Aug. 5, 2020, the entire contents of which are incorporated herein by reference.

### FIELD

The embodiments discussed herein are related to an information processing apparatus and a data processing method.

### BACKGROUND

The PBE (programming by example), which generates a program (hereinafter, referred to as a “conversion program”) capable of converting input data into output data by using examples of input data and output data, has recently appeared.

Specifically, for example, the PBE generates the conversion program by searching for a combination of intermediate programs needed for converting an example of input data into an example of output data, from multiple intermediate programs prepared in advance.

As a result, a user of the PBE (hereinafter, also simply referred to as a “user”) may use the generated conversion program, so as to generate output data that correspond to other input data (input data other than the example of the input data used for generating the conversion program).

Related technologies are disclosed in, for example, Japanese Laid-Open Patent Publication No. 2019-159362, Japanese National Publication of International Patent Application No. 2016-502701, and Japanese Laid-Open Patent Publication No. 10-171643.

### SUMMARY

According to an aspect of the embodiments, a non-transitory computer-readable recording medium has stored therein a program that causes a computer to execute a process, the process including generating token information that indicates a characteristic of an associating relation between input data and output data obtained by converting the input data according to a predetermined rule, and when searching for one or more intermediate programs used to generate a conversion program for converting the input data into the output data among multiple intermediate programs stored in a storage, excluding an intermediate program that does not correspond to the token information from candidates of the one or more intermediate programs.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a view illustrating a configuration of an information processing system;

FIG. 2 is a view illustrating a comparative example of a data processing in an information processing apparatus;

FIG. 3 is a view illustrating a comparative example of a data processing in the information processing apparatus;

FIG. 4 is a view illustrating a comparative example of a data processing in the information processing apparatus;

FIG. 5 is a view illustrating a comparative example of a data processing in the information processing apparatus;

FIG. 6 is a view illustrating a comparative example of a data processing in the information processing apparatus;

FIG. 7 is a view illustrating a hardware configuration of the information processing apparatus;

FIG. 8 is a functional block diagram of the information processing apparatus;

FIG. 9 is a flowchart illustrating an outline of a data processing according to a first embodiment;

FIG. 10 is a flowchart illustrating details of the data processing according to the first embodiment;

FIG. 11 is a flowchart illustrating details of the data processing according to the first embodiment;

FIG. 12 is a flowchart illustrating details of the data processing according to the first embodiment;

FIG. 13 is a flowchart illustrating details of the data processing according to the first embodiment;

FIG. 14 is a flowchart illustrating details of the data processing according to the first embodiment;

FIG. 15 is a flowchart illustrating details of the data processing according to the first embodiment;

FIG. 16 is a flowchart illustrating details of the data processing according to the first embodiment;

FIG. 17 is a flowchart illustrating details of the data processing according to the first embodiment;

FIG. 18 is a flowchart illustrating details of the data processing according to the first embodiment;

FIG. 19 is a flowchart illustrating details of the data processing according to the first embodiment;

FIG. 20 is a flowchart illustrating details of the data processing according to the first embodiment;

FIG. 21 is a flowchart illustrating details of the data processing according to the first embodiment;

FIG. 22 is a flowchart illustrating details of the data processing according to the first embodiment;

FIG. 23 is a flowchart illustrating details of the data processing according to the first embodiment;

FIG. 24 is a flowchart illustrating details of the data processing according to the first embodiment;

FIG. 25 is a flowchart illustrating details of the data processing according to the first embodiment;

FIGS. 26A to 26D are views illustrating specific examples of an input table, an output table, and token information;

FIGS. 27A to 27D are views illustrating specific examples of an input table, an output table, and token information;

FIGS. 28A to 28D are views illustrating specific examples of an input table, an output table, and token information; and

FIGS. 29A to 29D are views illustrating specific examples of an input table, an output table, and token information.

### DESCRIPTION OF EMBODIMENTS

When, for example, the input data and the output data are data in a table format, the size of each data may increase according to, for example, the number of cells included in the data, and as a result, an associating relation between the input data and the output data may become complicated. Thus, a user of an information processing apparatus may not search for an appropriate combination of intermediate programs (generation of the conversion program) in a relatively short time.

<Configuration of Information Processing System>

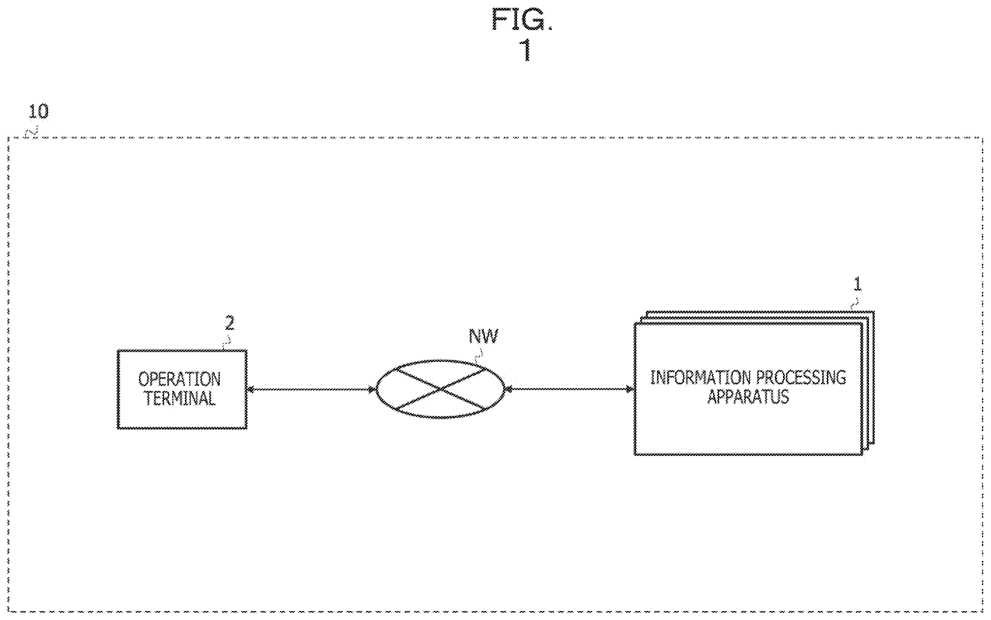

First, the configuration of an information processing system 10 will be described. FIG. 1 is a view illustrating the configuration of the information processing system 10.

As illustrated in FIG. 1, the information processing system 10 includes an information processing apparatus 1 configured by one or more physical machines, and an operation terminal 2 by which the user performs, for example, inputs of various types of information. The operation terminal 2 is, for example, a mobile terminal such as a desktop PC (personal computer) or a tablet, and may access the information processing apparatus 1 via a network NW such as the Internet.

In the information processing apparatus 1, a process of converting input data prepared in advance into output data (hereinafter, also referred to as a “data processing”) is performed. Hereinafter, a comparative example of the data processing in the information processing apparatus 1 will be described.

<Comparative Example of Data Processing in Information Processing Apparatus>

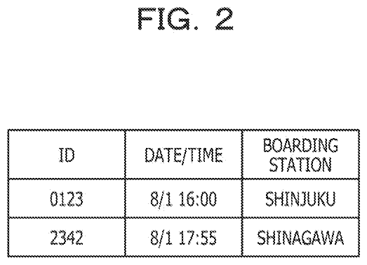

FIGS. 2 to 6 are views illustrating the comparative example of the data processing in the information processing apparatus 1. Hereinafter, it is assumed that each of the input data and the output data is data in a table format (hereinafter, also referred to as an input table and an output table).

First, a specific example of an input table 131 (a portion of the input table 131) used to generate the conversion program will be described. FIG. 2 is a view illustrating the specific example of a portion of the input table 131.

As illustrated in FIG. 2, the input table 131 includes the following items: “ID” in which data for identifying a user of a train is set; “Date/Time” in which date/time when each user uses the train is set; and “Boarding Station” in which a boarding station of the train used by the user is set.

Specifically, for the data of the first row in the input table 131 illustrated in FIG. 2, “0123” is set as the “ID,” “8/1 16:00” is set as the “Date/Time,” and “Shinjuku” is set as the “Boarding Station.”

Further, for the data of the second row in the input table 131 illustrated in FIG. 2, “2342” is set as the “ID,” “8/1 17:55” is set as the “Date/Time,” and “Shinagawa” is set as the “Boarding Station.”

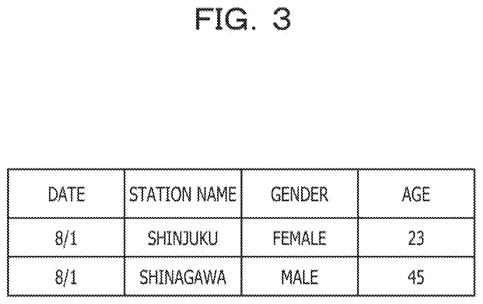

Next, a specific example of an output table 132 (a portion of the output table 132) used to generate the conversion program will be described. FIG. 3 is a view illustrating the specific example of a portion of the output table 132. Meanwhile, the output table 132 is a table generated by converting the input table 131 according to a predetermined rule.

As illustrated in FIG. 3, the output table 132 includes the following items: “Date” in which a date when each user uses a train is set; “Station Name” in which a boarding station of a train used by each user is set; “Gender” in which the gender of each user is set; and “Age” in which the age of each user is set.

Specifically, for the data of the first row in the output table 132 illustrated in FIG. 3, “8/1” is set as the “Date,” “Shinjuku” is set as the “Station Name,” “female” is set as the “Gender,” and “23 (years old)” is set as the “Age.”

Further, for the data of the second row in the output table 132 illustrated in FIG. 3, “8/1” is set as the “Date,” “Shinagawa” is set as the “Station Name,” “male” is set as the “Gender,” and “45 (years old)” is set as the “Age.”

Then, in this case, the information processing apparatus 1 combines multiple intermediate programs PG for performing various transformation processes on data, to generate the conversion program capable of converting the data set in each cell of the input table 131 illustrated in FIG. 2 (e.g., the data set in “Date/Time” and “Boarding Station”) into the data set in each cell of the output table 132 illustrated in FIG. 3 (e.g., the data set in “Date” and “Station Name”).

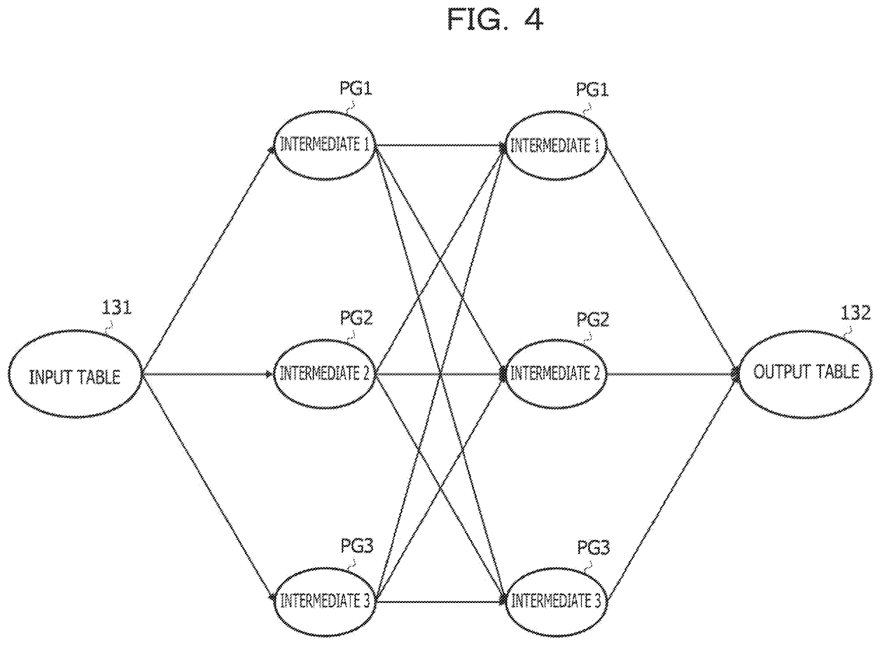

Specifically, as illustrated in FIG. 4, the information processing apparatus 1 comprehensively combines intermediate programs PG1, PR2, and PR3 prepared in advance, so as to search for a combination of intermediate programs PG capable of converting the data set in each cell of the input table 131 illustrated in FIG. 2 into the data set in each cell of the output table 132 illustrated in FIG. 3 (e.g., searching by an A* algorithm).

Then, by using the conversion program configured by the searched combination of intermediate programs PG, the information processing apparatus 1 converts another portion of the input table 131 (data other than the data used to generate the conversion program).

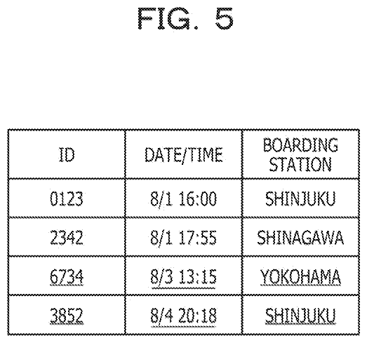

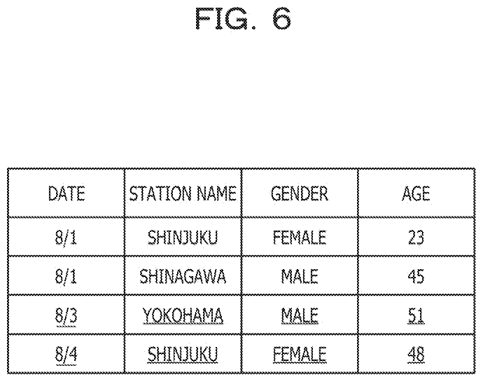

Specifically, as indicated by the underlines in FIGS. 5 and 6, the information processing apparatus 1 uses the conversion program, so as to convert the data set in the “Date/Time” and the “Boarding Station” of the third and fourth rows of the input table 131 into the data set in the “Date” and the “Station Name” in the third and fourth rows of the output table 132.

As a result, for example, even when the number of data included in the input table 131 is large, the information processing apparatus 1 may easily generate data to be set in each cell of the output table 132.

Meanwhile, in this case, the information processing apparatus 1 may refer to, for example, an auxiliary table (not illustrated) in which the “ID” included in the input table 131 and the “Gender” and “Age” included in the output table 132 are associated with each other, so as to specify the data associated with the data set in the “ID” of the third and fourth rows of the input table 131 as data to be set in the “Gender” and “Age” in the third and fourth rows of the output table 132.

Here, when the number of cells included in each of the input table 131 and the output table 132 is large, the data size of each table increases, and the associating relation of the cells included in each table becomes complicated. Thus, in this case, the user may not generate the conversion program for converting the input table 131 into the output table 132 in a short time.

Accordingly, the information processing apparatus 1 according to an embodiment of the present disclosure generates token information indicating characteristics of an associating relation between the input table 131 and the output table 132. Then, when searching for one or more intermediate programs PG used to generate the conversion program for converting the input table 131 into the output table 132 from multiple intermediate programs PG stored in a storage unit, the information processing apparatus 1 excludes intermediate programs PG that do not correspond to the generated token information, from candidates of intermediate programs PG used to generate the conversion program.

That is, for example, the information processing apparatus 1 according to the present embodiment specifies intermediate programs PG in advance which may be determined not to be selected for the generation of the conversion program, from the associating relation between the data set in each cell of the input table 131 and the data set in each cell of the output table 132. Then, the information processing apparatus 1 searches for a combination of intermediate programs PG used to generate the conversion program, from the intermediate programs PG other than the intermediate programs PG specified in advance among the intermediate programs PG stored in the storage unit.

As a result, the information processing apparatus 1 may limit the range for searching for a combination of intermediate programs PG used to generate the conversion program, in advance. Thus, the information processing apparatus 1 may generate the conversion program in a short time, for example, even when the data sizes of the input data to be converted and the output data in the input table 131 and the output table 132 are relatively large.

<Hardware Configuration of Information Processing Apparatus>

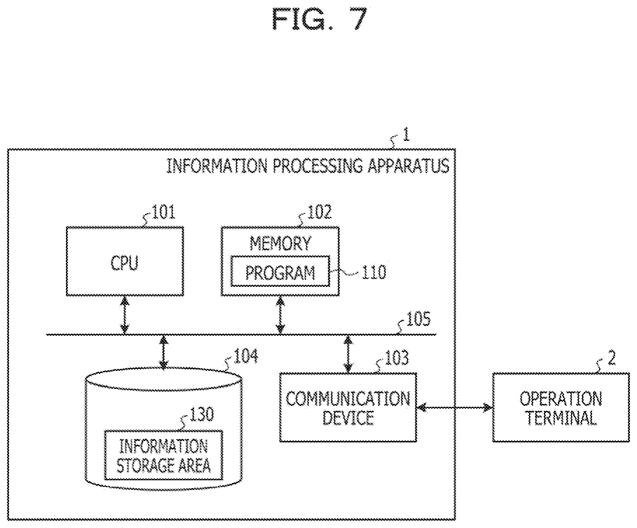

Next, the hardware configuration of the information processing apparatus 1 will be described. FIG. 7 is a view illustrating the hardware configuration of the information processing apparatus 1.

As illustrated in FIG. 7, the information processing apparatus 1 includes a CPU 101 which is a processor, a memory 102, a communication device 103, and a storage medium 104. The respective units are connected to each other via a bus 105.

The storage medium 104 includes, for example, a program storage area (not illustrated) for storing a program 110 for executing the data processing. Further, the storage medium 104 includes, for example, an information storage area 130 for storing information used when the data processing or the like is performed. Meanwhile, the storage medium 104 may be, for example, an HDD (hard disk drive) or an SSD (solid state drive).

The CPU 101 executes the program 110 loaded from the storage medium 104 into the memory 102 to perform the data processing.

The communication device 103 performs, for example, a communication with the operation terminal 2 via a network.

<Function of Information Processing Apparatus>

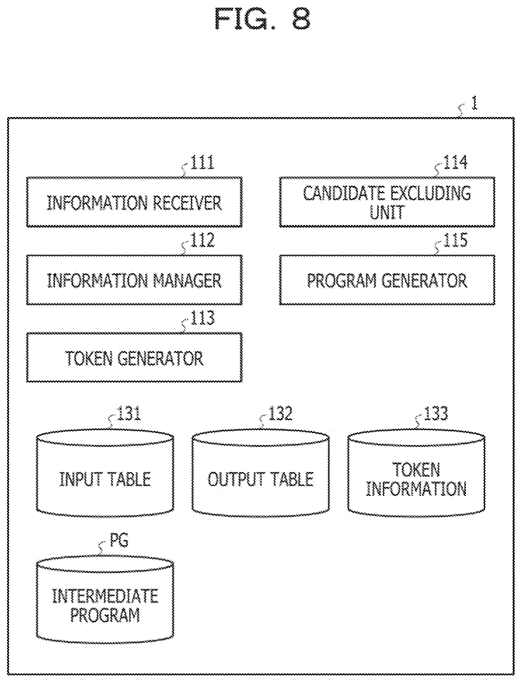

Next, the function of the information processing apparatus 1 will be described. FIG. 8 is a functional block diagram of the information processing apparatus 1.

As illustrated in FIG. 8, the information processing apparatus 1 functions as an information receiver 111, an information manager 112, and a token generator 113, a candidate excluding unit 114, and a program generator 115, in the manner that the hardware such as the CPU 101, the memory 102 or the like cooperates with the program 110.

Further, for example, as illustrated in FIG. 8, the information processing apparatus 1 stores the input table 131, the output table 132, token information 133, and the intermediate programs PG in the information storage area 130.

For example, the information receiver 111 receives the input table 131 and the output table 132 input by a user through the operation terminal 2.

For example, the information manager 112 stores the input table 131 and the output table 132 received by the information receiver 111 in the information storage area 130.

The token generator 113 generates the token information 133 that indicates the characteristics of the associating relation between each cell of the input table 131 stored in the information storage area 130 and each cell of the output table 132 stored in the information storage area 130.

The candidate excluding unit 114 excludes intermediate programs PG that do not correspond to the token information 133 generated by the token generator 113, among the intermediate programs PG stored in the information storage area 130.

The program generator 115 searches for the intermediate programs PG other than the intermediate programs PG excluded by the candidate excluding unit 114 (the intermediate programs PG that are not excluded by the candidate excluding unit 114), so as to specify a combination of intermediate programs PG capable of converting the input table 131 stored in the information storage area 130 into the output table 132 stored in the information storage area 130. Then, the program generator 115 generates the conversion program configured by the specified combination of intermediate programs PG.

<Outline of First Embodiment>

Next, the outline of the first embodiment will be described.

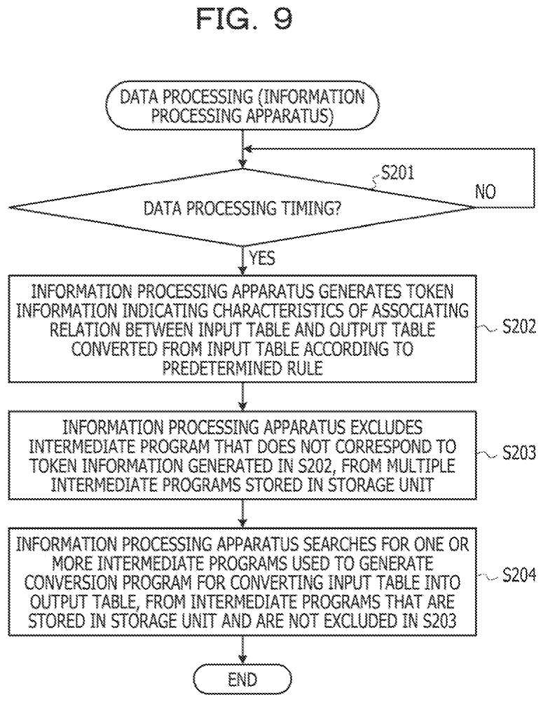

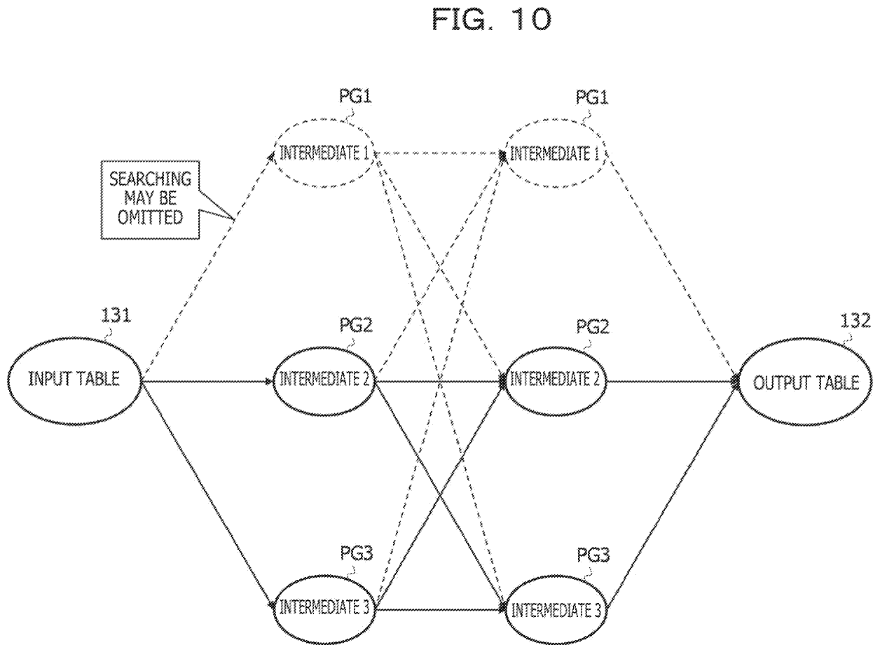

FIG. 9 is a flowchart illustrating the outline of the data processing according to the first embodiment. FIG. 10 is a view illustrating the output of the data processing according to the first embodiment.

As illustrated in FIG. 9, the information processing apparatus 1 waits until a data processing timing approaches (NO in S201). The data processing timing may be, for example, a timing when the user inputs the input table 131 and the output table 132 through the operation terminal 2. Further, the data processing timing may be, for example, a timing when the user inputs information for executing the conversion of the input table 131 through the operation terminal 2.

Then, when the data processing timing approaches (YES in S201), for example, the information processing apparatus 1 generates the token information 133 that indicates the characteristics of the associating relation between the input table 131 and the output table 132 converted from the input table 131 according to a predetermined rule (a conversion rule) (S202).

Subsequently, the information processing apparatus 1 excludes intermediate programs PG that do not correspond to the token information 133 generated in the process of S202, from the multiple intermediate programs PG stored in the information storage area 130 (S203).

Then, the information processing apparatus 1 searches for one or more intermediate programs PG used to generate a conversion program PR for converting the input table 131 into the output table 132, from the intermediate programs PG that are stored in the information storage area 130 and have not been excluded by the process of S203 (S204).

That is, for example, the information processing apparatus 1 according to the present embodiment specifies the intermediate programs PG, in advance, which may be determined not to be selected for the generation of the conversion program, from the associating relation between the data set in each cell of the input table 131 and the data set in each cell of the output table 132. Then, the information processing apparatus 1 searches for a combination of intermediate programs PG used to generate the conversion program, from the intermediate programs PG other than the intermediate programs PG specified in advance among the intermediate programs PG stored in the information storage area 130.

Specifically, for example, as illustrated in FIG. 10, when an intermediate program PG1 is specified as an intermediate program PG that is not to be selected for the generation of the conversion program, the information processing apparatus 1 prunes the intermediate program PG1. Then, the information processing apparatus 1 searches for a combination of intermediate programs PG used to generate the conversion program, from the intermediate programs PG other than the intermediate program PG1 (intermediate programs PG2 and PG3).

As a result, the information processing apparatus 1 may limit the range for searching for a combination of intermediate programs PG used to generate the conversion program, in advance. Thus, the information processing apparatus 1 may generate the conversion program for converting the input table 131 into the output table 132 in a short time, for example, even when the data sizes of the input table 131 to be converted and the output data 132 are large.

<Details of First Embodiment>

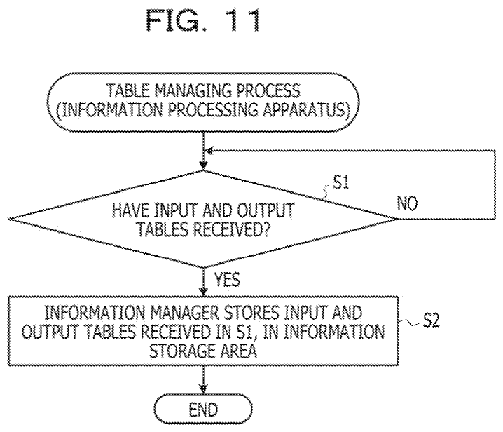

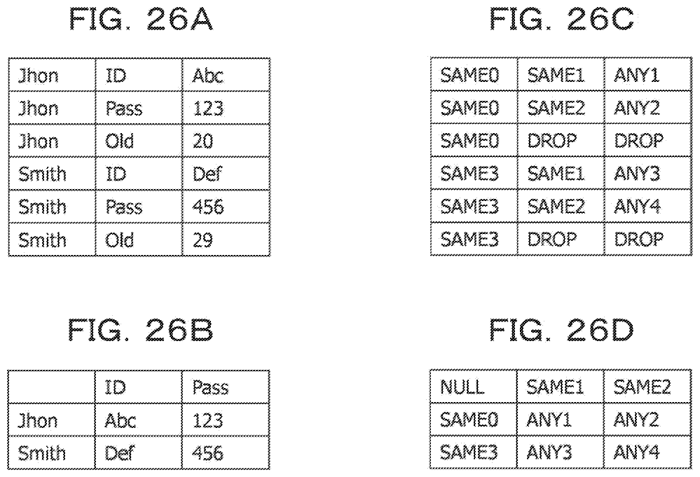

Next, details of the first embodiment will be described. FIGS. 11 to 25 are flowcharts illustrating the details of the data processing according to the first embodiment. Further, FIGS. 26A to 26D through 29A to 29D are views illustrating the details of the data processing according to the first embodiment. Hereinafter, it is assumed that an intermediate program PG is a program described by the DSL (domain specific language) specialized for data in a table format.

<Table Managing Process>

First, in the data processing, a process of managing the input table 131 and the output table 132 (hereinafter, also referred to as a table managing process) will be described. FIG. 11 is a flowchart illustrating the table managing process.

As illustrated in FIG. 11, for example, the information receiver 111 of the information processing apparatus 1 waits until the input table 131 and the output table 132 transmitted from the operation terminal 2 are received (NO in S1).

Then, when the input table 131 and the output table 132 transmitted from the operation terminal 2 are received (YES in S1), the information manager 112 of the information processing apparatus 1 stores the received input table 131 and output table 132 in the information storage area 130 (S2).

<Token Generating Process>

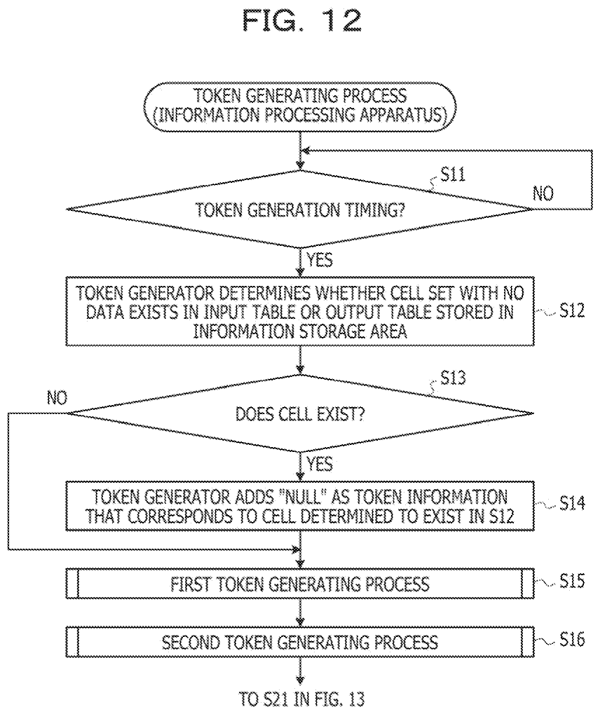

Next, in the data processing, a process of generating the token information 133 (hereinafter, also referred to as a token generating process) will be described. FIGS. 12 to 24 are flowcharts illustrating the token generating process.

The token generator 113 of the information processing apparatus 1 waits until a token generation timing comes (NO in S11). The token generation timing may be, for example, a timing when the user inputs information for executing the generation of the token information 133 through the operation terminal 2.

Then, when the token generation timing comes (YES in S11), the token generator 113 determines whether a cell set with no data exists in the input table 131 or the output table 132 stored in the information storage area 130 (S12).

As a result, when it is determined that a cell set with no data exists in the input table 131 or the output table 132 stored in the information storage area 130 (YES in S13), the token generator 113 adds “Null” as the token information 133 that corresponds to the cell determined to exist in the process of S12 (S14).

That is, in this case, the token generator 113 adds “Null” which is the token information 133 indicating that no data is set in the cell determined to exist in the process of S12, as the token information 133 that corresponds to the cell determined to exist in the process of S12.

Meanwhile, when it is determined that a cell set with no data does not exist in the input table 131 and the output table 132 stored in the information storage area 130 (NO in S13), the token generator 113 does not perform the process of S14. Hereinafter, a specific example of the processes of S12 to S14 will be described.

<Specific Example of Processes of S12 to S14>

FIGS. 26A to 26D through 29A to 29D are views illustrating specific examples of the input table 131, the output table 132, and the token information 133. Specifically, FIGS. 26A, 27A, 28A, and 29A are each a view illustrating a specific example of the input table 131, and FIGS. 26B, 27B, 28B, and 29B are each a view illustrating a specific example of the output table 132. Further, FIGS. 26C, 27C, 28C, and 29C are each a view illustrating a specific example of the token information 133 that corresponds to the input table 131 (hereinafter, also referred to as token information 133a), and FIGS. 26D, 27D, 28D, and 29D are each a view illustrating a specific example of the token information 133 that corresponds to the output table 132 (hereinafter, also referred to as token information 133b).

Hereinafter, descriptions will be made assuming that the cells of the token information 133a illustrated in FIGS. 26C, 27C, 28C, and 29C are identical to the cells of the input table 131 illustrated in FIGS. 26A, 27A, 28A, and 29A in terms of the number of rows and the number of columns. Further, hereinafter, descriptions will be made assuming that the cells of the token information 133b illustrated in FIGS. 26D, 27D, 28D, and 29D are identical to the cells of the output table 132 illustrated in FIGS. 26B, 27B, 28B, and 29B in terms of the number of rows and the number of columns. Further, hereinafter, among the cells of an M-th row in the input table 131, the output table 132 or the token information 133, a cell of an N-th column in the input table 131, the output table 132 or the token information 133 will be referred to as a “cell of the M-th row/the N-th column.”

Specifically, no data is set in the cell of the first row/the first column of the output data 132 illustrated in FIG. 26B. Thus, the token generator 113 sets “Null” in the first row/the first column of the token information 133b illustrated in FIG. 26D.

Referring back to FIG. 12, the token generator 113 executes a first token generating process after the process of S14 (S15). Hereinafter, the first token generating process will be described.

<First Token Generating Process>

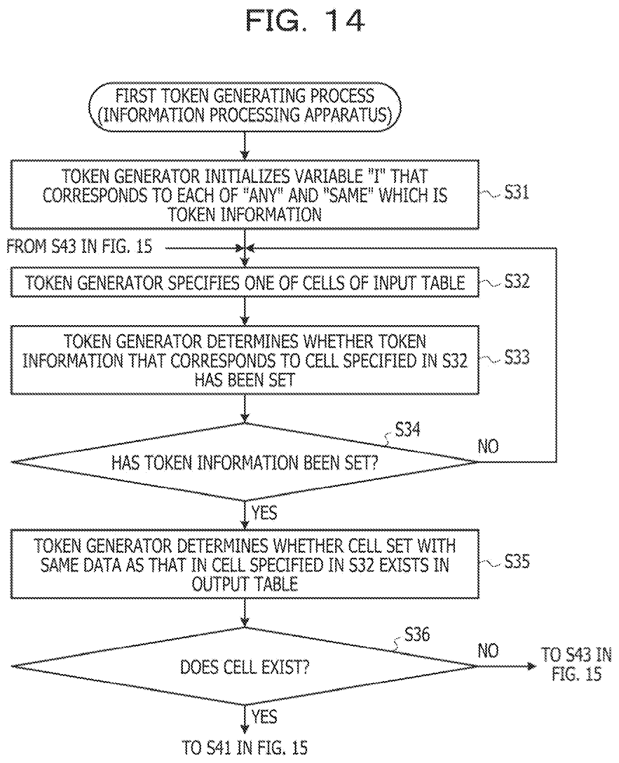

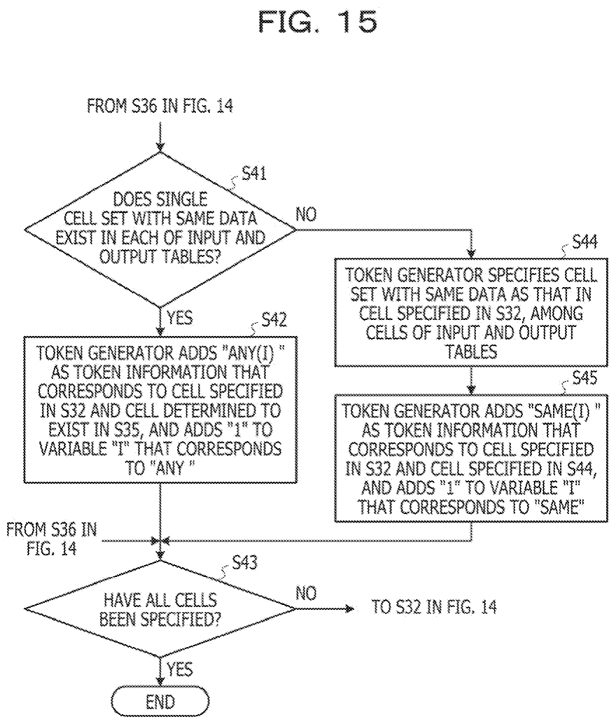

FIGS. 14 to 15 are flowcharts illustrating the first token generating process. The first token generating process is a process of generating “ANY” and “SAME” as the token information 133.

As illustrated in FIG. 14, the token generator 113 initializes a variable “i” (which functions as a counter) that corresponds to each of “ANY” and “SAME” which is the token information 133 (S31).

Specifically, for example, the token generator 113 sets “1” in the variable “i” that corresponds to each of “ANY” and “SAME.”

Then, the token generator 113 specifies one of the cells that make up the input table 131 stored in the information storage area 130 (S32).

Subsequently, the token generator 113 determines whether the token information 133 that corresponds to the cell specified in the process of S32 has been set (S33).

As a result, when it is determined that the token information 133 that corresponds to the cell specified in the process of S32 has been set (YES in S34), the token generator 113 performs the processes of S32 and subsequent steps again.

Meanwhile, when it is determined that the token information 133 that corresponds to the cell specified in the process of S32 has not been set (NO in S34), the token generator 113 determines whether a cell set with the same data as that in the cell specified in the process of S32 exists in the output table 132 (S35).

Then, as illustrated in FIG. 15, when it is determined that a cell set with the same data as that in the cell specified in the process of S32 exists in the output table 132, and when it is determined when the single cell set with the same data as that in the cell specified in the process of S32 exists in each of the input table 131 and the output table 132 (YES in S36 and YES in S41), the token generator 113 adds “ANY(i)” as the token information 133 that corresponds to the cell specified in the process of S32 and the cell determined to exist in the process of S35 (S42). Further, in this case, the token generator 113 adds “1” to the variable “i” that corresponds to “ANY” (S42).

That is, in this case, the token generator 113 adds “ANY” which is the token information 133 indicating that the single cell set with the same data as that in the cell specified in the process of S32 exists in each of the input table 131 and the output table 132, as the token information 133 that corresponds to the cell specified in the process of S32 and the cell determined to exist in the process of S35.

Meanwhile, when it is determined that a cell set with the same data as that in the cell specified in the process of S32 exists in the output table 132, and when it is determined that multiple cells set with the same data as that in the cell specified in the process of S32 exist in at least one of the input table 131 and the output table 132 (YES in S36 and NO in S41), the token generator 113 specifies the cells set with the same data as that in the cell specified in the process of S32, among the cells that make up the input table 131 and the output table 132 stored in the information storage area 130 (S44).

Then, the token generator 113 adds “SAME(i)” as the token information 133 that corresponds to the cell specified in the process of S32 and the cells specified in the process of S44, and adds “1” to the variable “i” that corresponds to “SAME” (S45).

That is, in this case, the token generator 113 adds “SAME” which is the token information 133 indicating that one or more cells set with the same data as that in the cell specified in the process of S32 exist in each of the input table 131 and the output table 132, and indicating that multiple cells set with the same data as that in the cell specified in the process of S32 exist in at least one of the input table 131 and the output table 132, as the token information 133 that corresponds to the cell specified in the process of S32 and the cells specified in the process of S44.

Subsequently, after the process of S42 or S44, the token generator 113 determines whether all of the cells of the input table 131 have been acquired in the process of S32 (S43).

As a result, when it is determined that all of the cells of the input table 131 have not been acquired in the process of S32 (NO in S43), the token generator 113 performs the processes of S32 and subsequent processes again.

Meanwhile, when it is determined that all of the cells of the input table 131 have been acquired in the process of S32 (YES in S43), the token generator 113 ends the first token generating process.

Meanwhile, the token generator 113 identically performs the process of S43 even when it is determined in the process of S36 that a cell set with the same data as that in the cell specified in the process of S32 does not exist in the output table 132 (NO in S36). Hereinafter, a specific example of the first token generating process will be described

<Specific Example of First Token Generating Process>

“Abc” is set in each of the cell of the first row/the third column in the input table 131 illustrated in FIG. 26A and the cell of the second row/the second column in the output table 132 illustrated in FIG. 26B. The “Abc” is not set in the other cells of the input table 131 illustrated in FIG. 26A and the output table 132 illustrated in FIG. 26B. Thus, for example, the token generator 113 sets “ANY1” in each of the cell of the first row/the third column in the token information 133a illustrated in FIG. 26C and the cell of the second row/the second column in the token information 133b illustrated in FIG. 26D.

Further, “123” is set in each of the cell of the second row/the third column in the input table 131 illustrated in FIG. 26A and the cell of the second row/the third column in the output table 132 illustrated in FIG. 26B. The “123” is not set in the other cells of the input table 131 illustrated in FIG. 26A and the output table 132 illustrated in FIG. 26B. Thus, for example, the token generator 113 sets “ANY2” in each of the cell of the second row/the third column in the token information 133a illustrated in FIG. 26C and the cell of the second row/the third column in the token information 133b illustrated in FIG. 26D.

Further, “ID” is set in each of the cells of the first row/the second column and the fourth row/the second column in the input table 131 illustrated in FIG. 26A and the cell of the first row/the second column in the output table 132 illustrated in FIG. 26B. Thus, for example, the token generator 113 sets “SAME1” in each of the cells of the first row/the second column and the fourth row/the second column in the token information 133a illustrated in FIG. 26C and the cell of the first row/the second column in the token information 133b illustrated in FIG. 26D.

Further, “Pass” is set in each of the cells of the second row/the second column and the fifth row/the second column in the input table 131 illustrated in FIG. 26A and the cell of the first row/the third column in the output table 132 illustrated in FIG. 26B. Thus, for example, the token generator 113 sets “SAME2” in each of the cells of the second row/the second column and the fifth row/the second column in the token information 133a illustrated in FIG. 26C and the cell of the first row/the third column in the token information 133b illustrated in FIG. 26D.

Referring back to FIG. 12, the token generator 113 executes a second token generating process after the first token generating process is completed (S16). Hereinafter, the second token generating process will be described.

<Second Token Generating Process>

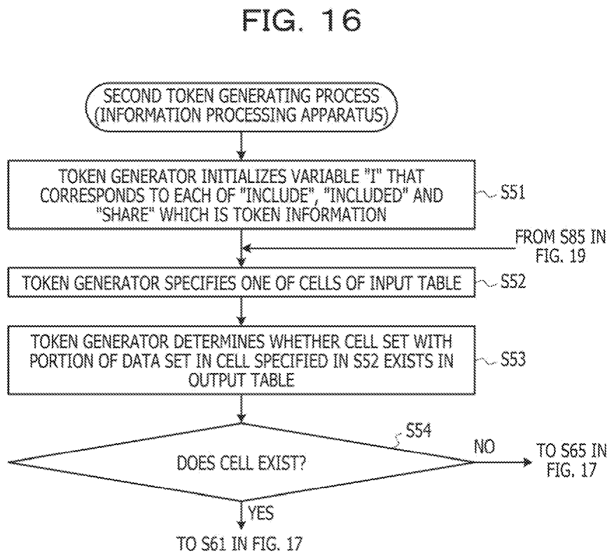

FIGS. 16 to 19 are flowcharts illustrating the second token generating process. The second token generating process is a process of generating “INCLUDE,” “INCLUDED,” and “SHARE” as the token information 133.

As illustrated in FIG. 16, the token generator 113 initializes a variable “i” that corresponds to each of “INCLUDE,” “INCLUDED,” and “SHARE” which is the token information 133 (S51).

Specifically, for example, the token generator 113 sets “1” in the variable “i” that corresponds to each of “INCLUDE,” “INCLUDED,” and “SHARE.”

Then, the token generator 113 specifies one of the cells that make up the input table 131 stored in the information storage area 130 (S52).

Subsequently, the token generator 113 determines whether a cell set with a portion of the data set in the cell specified in the process of S52 exists in the output table 132 stored in the information storage area 130 (S53).

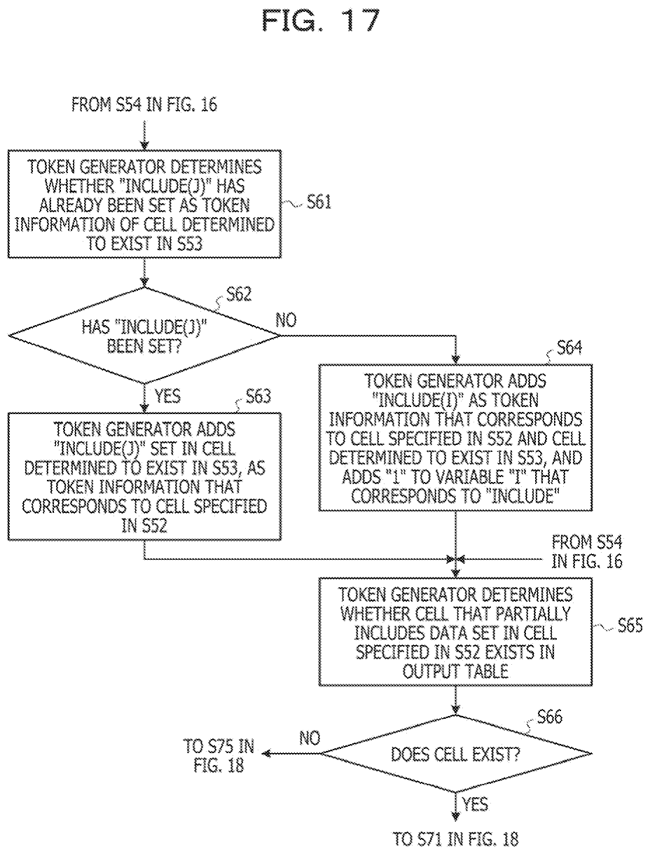

As a result, when it is determined that a cell set with a portion of the data set in the cell specified in the process of S52 exists in the output table 132 stored in the information storage area 130 (YES in S54), the token generator 113 determines whether “INCLUDE(j)” has already been set as the token information 133 of the cell determined to exist in the process of S53, as illustrated in FIG. 17 (S61). The “INCLUDED(j)” is the token information 133 added in a process of S64 that has already been performed.

Then, when it is determined that “INCLUDE(j)” has already been set as the token information 133 of the cell determined to exist in the process of S53 (YES in S62), the token generator 113 adds “INCLUDE(j)” set in the cell determined to exist in the process of S53, as the token information 133 that corresponds to the cell specified in the process of S52 (S63).

Meanwhile, when it is determined that “INCLUDE(j)” has not been set as the token information 133 of the cell determined to exist in the process of S53 (NO in S62), the token generator 113 adds “INCLUDE(i)” as the token information 133 that corresponds to the cell specified in the process of S52 and the cell determined to exist in the process of S53 (S64). Then, in this case, the token generator 113 adds “1” to the variable “i” that corresponds to “INCLUDE” (S64).

That is, in this case, the token generator 113 adds “INCLUDE” which is the token information 133 indicating that a cell set with a portion of the data set in the cell specified in the process of S52 exists in the output table 132, as the token information 133 that corresponds to the cell specified in the process of S52 and the cell determined to exist in the process of S53.

Subsequently, after the process of S63 or S64, the token generator 113 determines whether a cell that partially includes the data set in the cell specified in the process of S52 exists in the output table 132 stored in the information storage area 130 (S65).

Meanwhile, the token generator 113 identically performs the process of S65 even when it is determined in the process of S54 that a cell set with a portion of the data set in the cell specified in the process of S52 does not exist in the output table 132 stored in the information storage area 130 (NO in S54).

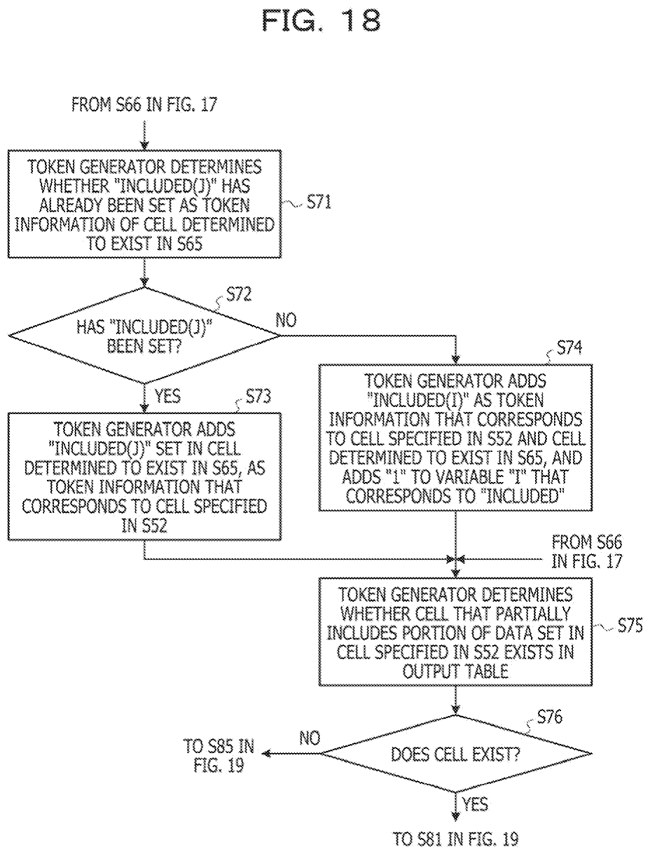

As a result, when it is determined that a cell that partially includes the data set in the cell specified in the process of S52 exists in the output table 132 stored in the information storage area 130 (YES in S66), the token generator 113 determines whether “INCLUDED(j)” has already been set as the token information 133 of the cell determined to exist in the process of S65, as illustrated in FIG. 18 (S71). The “INCLUDED(j)” is the token information 133 added in a process of S74 that has already been performed.

Then, when it is determined that “INCLUDED(j)” has already been set as the token information 133 of the cell determined to exist in the process of S65 (YES in S72), the token generator 113 adds “INCLUDED(j)” set in the cell determined to exist in the process of S65, as the token information 133 that corresponds to the cell specified in the process of S52 (S73).

Meanwhile, when it is determined that “INCLUDED(j)” has not been set as the token information 133 of the cell determined to exist in the process of S65 (NO in S72), the token generator 113 adds “INCLUDED(i)” as the token information 133 that corresponds to the cell specified in the process of S52 and the cell determined to exist in the process of S65 (S74). Then, in this case, the token generator 113 adds “1” to the variable “i” that corresponds to “INCLUDED” (S74).

That is, the token generator 113 adds “INCLUDED” which is the token information 133 indicating that a cell that partially includes the data set in the cell specified in the process of S52 exists in the output table 132, as the token information 133 that corresponds to the cell specified in the process of S52 and the cell determined to exist in the process of S65.

Subsequently, after the process of S73 or S74, the token generator 113 determines whether a cell that partially includes a portion of the data set in the cell specified in the process of S52 exists in the output table 132 stored in the information storage area 130 (S75).

Meanwhile, the token generator 113 identically performs the process of S75 even when it is determined in the process of S66 that a cell that partially includes the data set in the cell specified in the process of S52 does not exist in the output table 132 stored in the information storage area 130 (NO in S66).

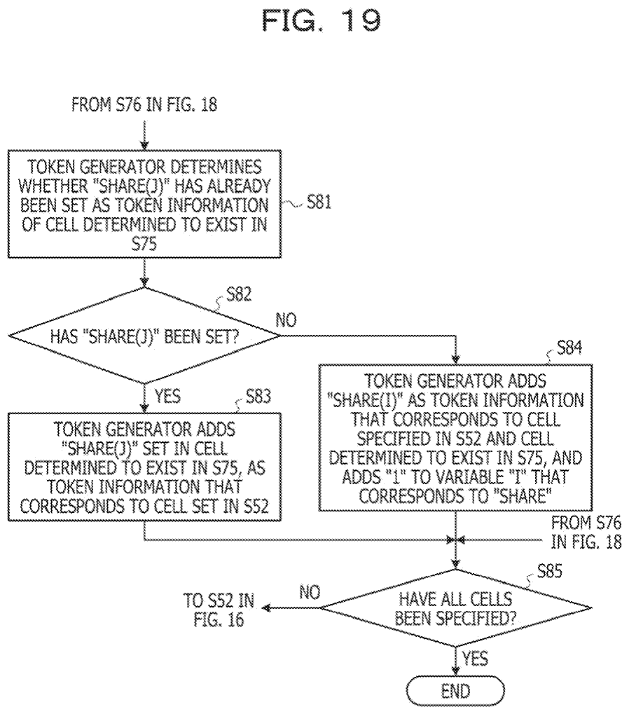

As a result, when it is determined that a cell that partially includes a portion of the data set in the cell specified in the process of S52 exists in the output table 132 stored in the information storage area 130 (YES in S76), the token generator 113 determines whether “SHARE(j)” has already been set as the token information 133 of the cell determined to exist in the process of S75 (S81), as illustrated in FIG. 19. The “SHARE(j)” is the token information 133 added in a process of S84 that has already been performed.

Then, when it is determined that “SHARE(j)” has already been set as the token information 133 of the cell determined to exist in the process of S75 (YES in S82), the token generator 113 adds “SHARE(j)” set in the cell determined to exist in the process of S75, as the token information 133 that corresponds to the cell specified in the process of S52 (S83).

Meanwhile, when it is determined that “SHARE(j)” has not been set as the token information 133 of the cell determined to exist in the process of S75 (NO in S82), the token generator 113 adds “SHARE(i)” as the token information 133 that corresponds to the cell specified in the process of S52 and the cell determined to exist in the process of S75 (S84). Then, in this case, the token generator 113 adds “1” to the variable “i” that corresponds to “SHARE” (S84).

That is, the token generator 113 adds “SHARE” which is the token information 133 indicating that a cell that partially includes a portion of the data set in the cell specified in the process of S52 exists in the output table 132, as the token information 133 that corresponds to the cell specified in the process of S52 and the cell determined to exist in the process of S75.

Then, after the process of S83 or S84, the token generator 113 determines whether all of the cells of the input table 131 have been acquired in the process of S52 (S85).

As a result, when it is determined that all of the cells of the input table 131 have not been acquired in the process of S52 (NO in S85), the token generator 113 performs the process of S52 and subsequent steps again.

Meanwhile, when it is determined that all of the cells of the input table 131 have been acquired in the process of S52 (YES in S85), the token generator 113 ends the second token generating process.

Meanwhile, the token generator 113 identically performs the process of S85 even when it is determined that a cell that partially includes a portion of the data set in the cell specified in the process of S52 does not exist in the output table 132 (NO in S76). Hereinafter, a specific example of the second token generating process will be described.

<Specific Example of Second Token Generating Process>

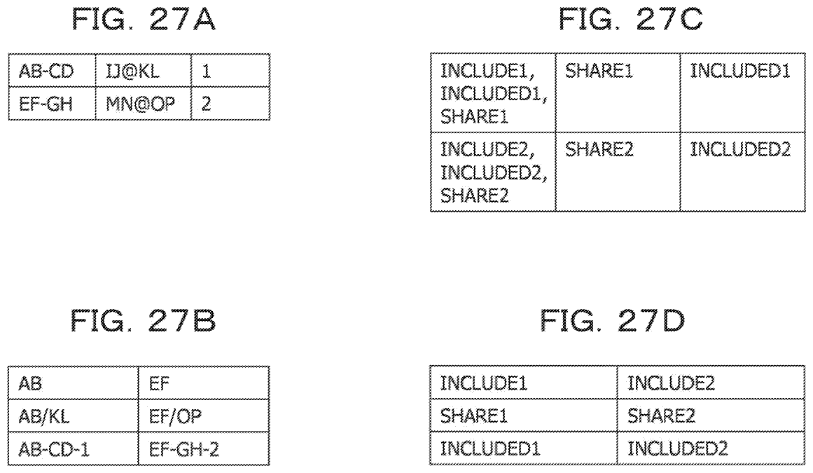

The “AB-CD” set in the cell of the first row/the first column of the input table 131 illustrated in FIG. 27A partially includes “AB” set in the cell of the first row/the first column of the output table 132 illustrated in FIG. 27B. Thus, for example, the token generator 113 sets “INCLUDE1” in each of the cell of the first row/the first column of the token information 133a illustrated in FIG. 27C and the cell of the first row/the first column of the token information 133b illustrated in FIG. 27D.

Further, “EF-GH” set in the cell of the second row/the first column of the input table 131 illustrated in FIG. 27A partially includes “EF” set in the cell of the first row/the second column of the output table 132 illustrated in FIG. 27B. Thus, for example, the token generator 113 sets “INCLUDE2” in each of the cell of the second row/the first column of the token information 133a illustrated in FIG. 27C and the cell of the first row/the second column of the token information 133b illustrated in FIG. 27D.

Further, “AB-CD” set in the cell of the first row/the first column of the input table 131 illustrated in FIG. 27A and “1” set in the cell of the first row/the third column of the input table 131 illustrated in FIG. 27A are each included in “AB-CD-1” set in the cell of the third row/the first column of the output table 132 illustrated in FIG. 27B. Thus, for example, the token generator 113 sets “INCLUDED1” in each of the cells of the first row/the first column and the first row/the third column of the token information 133a illustrated in FIG. 27C, and the cell of the third row/the first column of the token information 133b illustrated in FIG. 27D.

Further, “EF-GH” set in the cell of the second row/the first column of the input table 131 illustrated in FIG. 27A and “2” set in the cell of the second row/the third column of the input table 131 illustrated in FIG. 27A are each included in “EF-GH-2” set in the cell of the third row/the second column of the output table 132 illustrated in FIG. 27B. Thus, for example, the token generator 113 sets “INCLUDED2” in each of the cells of the second row/the first column and the second row/the third column of the token information 133a illustrated in FIG. 27C, and the cell of the third row/the second column of the token information 133b illustrated in FIG. 27D.

Further, “AB-CD” set in the cell of the first row/the first column of the input table 131 illustrated in FIG. 27A and “AB/KL” set in the cell of the second row/the first column of the output table 132 illustrated in FIG. 27B each partially includes “AB.” Further, “IJ@KL” set in the cell of the first row/the second column of the input table 131 illustrated in FIG. 27A and “AB/KL” set in the cell of the second row/the first column of the output table 132 illustrated in FIG. 27B each partially includes “KL.” Thus, for example, the token generator 113 sets “SHARE1” in each of the cells of the first row/the first column and the first row/the second column of the token information 133a illustrated in FIG. 27C, and the cell of the second row/the first column of the token information 133b illustrated in FIG. 27D.

Further, “EF-GH” set in the cell of the second row/the first column of the input table 131 illustrated in FIG. 27A and “EF/OP” set in the cell of the second row/the second column of the output table 132 illustrated in FIG. 27B each partially includes “EF.” Further, “MN@OP” set in the cell of the second row/the second column of the input table 131 illustrated in FIG. 27A and “EF/OP” set in the cell of the second row/the second column of the output table 132 illustrated in FIG. 27B each partially includes “OP.” Thus, for example, the token generator 113 sets “SHARE2” in each of the cells of the second row/the first column and the second row/the second column of the token information 133a illustrated in FIG. 27C, and the cell of the second row/the second column of the token information 133b illustrated in FIG. 27D.

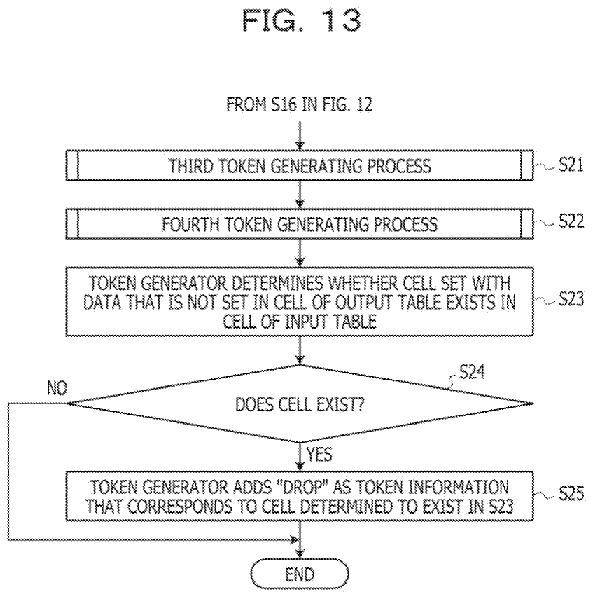

Referring back to FIG. 13, the token generator 113 executes a third token generating process after the second token generating process is completed (S21). Hereinafter, the third token generating process will be described.

<Third Token Generating Process>

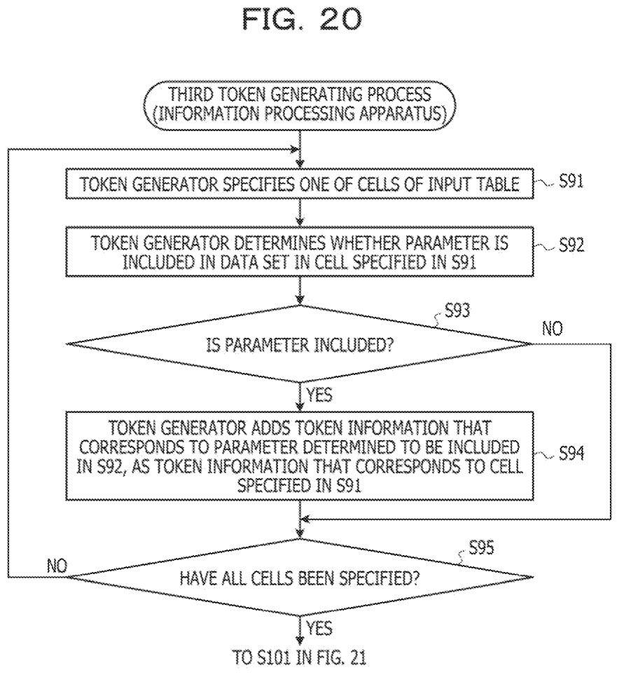

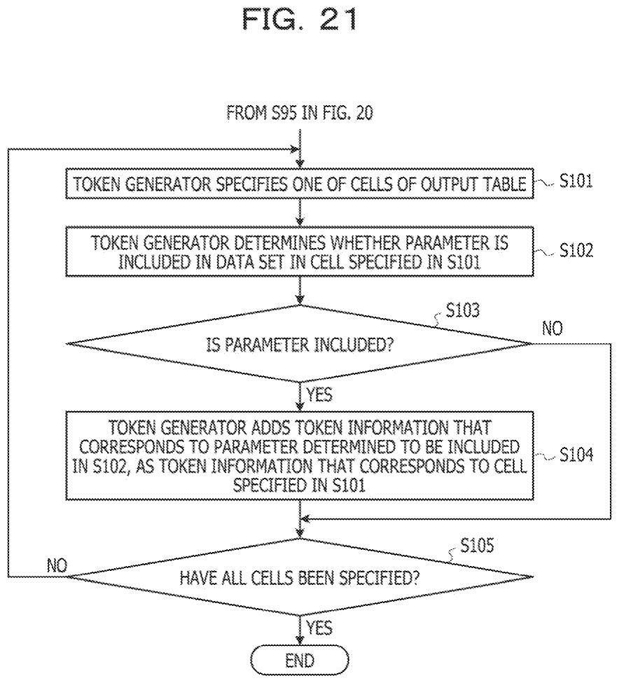

FIGS. 20 and 21 are flowcharts illustrating the third token generating process. The third token generating process is a process of generating token information 133 that corresponds to a parameter set in the input table 131 or the output table 132.

The token generator 113 specifies one of the cells that make up the input table 131 stored in the information storage area 130 (S91).

Then, the token generator 113 determines whether the data set in the cell specified in the process of S91 includes a parameter (S92).

Specifically, for example, the token generator 113 determines whether the data set in the cell specified in the process of S91 includes “@” indicating that two data obtained by dividing the data set in the cell specified in the process of S91 are data to be set in two different cells of the output table 132.

As a result, when it is determined that the data set in the cell specified in the process of S91 includes the parameter (YES in S93), the token generator 113 adds the token information 133 that corresponds to the parameter determined to be included in the process of S92, as the token information 133 that corresponds to the cell specified in the process of S91 (S94).

Meanwhile, when it is determined that the data set in the cell specified in the process of S91 does not include the parameter (NO in S93), the token generator 113 does not perform the process of S94.

Thereafter, it is determined whether all of the cells of the input table 131 have been acquired in the process of S91 (S95).

As a result, when it is determined that all of the cells of the input table 131 have not been acquired in the process of S91 (NO of S95), the token generator 113 performs the processes of S91 and subsequent steps again.

Meanwhile, when it is determined that all of the cells of the input table 131 have been acquired in the process of S91 (YES in S95), the token generator 113 specifies one of the cells that make up the output table 132 stored in the information storage area 130 as illustrated in FIG. 21 (S101).

Then, the token generator 113 determines whether the data set in the cell specified in the process of S101 includes a parameter (S102).

Specifically, for example, the token generator 113 determines whether the data set in the cell specified in the process of S101 includes “-” indicating that the data set in the cell specified in the process of S101 is a combination of data set in two cells of the input table 131.

As a result, when it is determined that the data set in the cell specified in the process of S101 includes the parameter (YES in S103), the token generator 113 adds the token information 133 that corresponds to the parameter determined to be included in the process of S101, as the token information 133 that corresponds to the cell specified in the process of S101 (S104).

Meanwhile, when it is determined that the data set in the cell specified in the process of S101 does not include the parameter (NO of S103), the token generator 113 does not perform the process of S104.

Thereafter, it is determined whether all of the cells of the input table 131 have been acquired in the process of S101 (S105).

As a result, when it is determined that all of the cells of the input table 131 have not been acquired in the process of S101 (NO in S105), the token generator 113 performs the processes of S101 and subsequent steps again.

Meanwhile, when it is determined that all of the cells of the input table 131 have been acquired in the process of S101 (YES in S105), the token generator 113 ends the third token generating process.

<Specific Example of Third Token Generating Process>

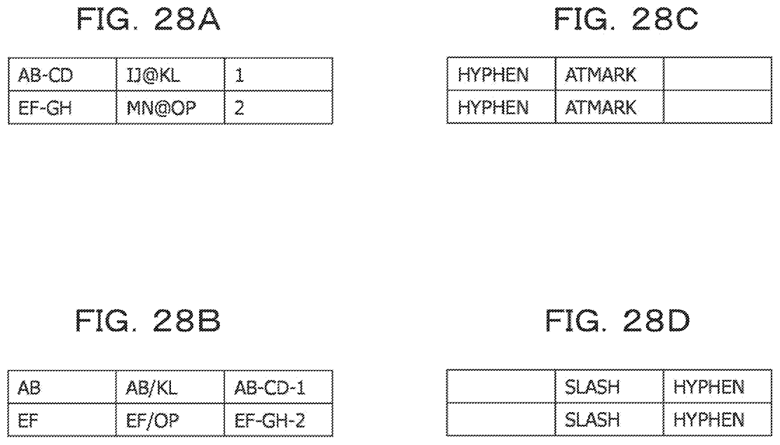

“AB-CD” set in the cell of the first row/the first column of the input table 131 illustrated in FIG. 28A includes the parameter “-.” Thus, for example, the token generator 113 sets “HYPHEN” in the cell of the first row/the first column of the token information 133a illustrated in FIG. 28C.

Further, “IJ@KL” set in the cell of the first row/the second column of the input table 131 illustrated in FIG. 28A includes the parameter “@.” Thus, for example, the token generator 113 sets “ATMARK” in the cell of the first row/the second column of the token information 133a illustrated in FIG. 28C.

Further, “AB/KL” set in the cell of the first row/the second column of the input table 131 illustrated in FIG. 28B includes the parameter “/.” Thus, for example, the token generator 113 sets “SLASH” in the cell of the first row/the second column of the token information 133a illustrated in FIG. 28D.

Further, “AB-CD-1” set in the cell of the first row/the third column of the input table 131 illustrated in FIG. 28B includes the parameter “-.” Thus, for example, the token generator 113 sets “HYPHEN” in the cell of the first row/the third column of the token information 133a illustrated in FIG. 28D.

Referring back to FIG. 13, the token generator 113 executes a fourth token generating process after the third token generating process is completed (S22). Hereinafter, the fourth token generating process will be described.

<Fourth Token Generating Process>

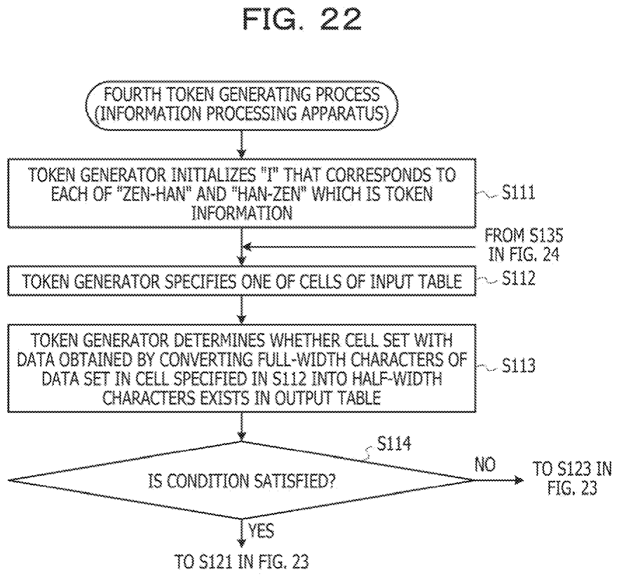

FIGS. 22 to 24 are flowcharts illustrating the fourth token generating process. The fourth token generating process is a process of generating “ZEN-HAN” and “HAN-ZEN” as the token information 133.

As illustrated in FIG. 22, the token generator 113 initializes a variable “i” that corresponds to each of “ZEN-HAN” and “HAN-ZEN” which is the token information 133 (S111).

Specifically, for example, the token generator 113 sets “1” in the variable “i” that corresponds to each of “ZEN-HAN” and “HAN-ZEN.”

Then, the token generator 113 specifies one of the cells that make up the input table 131 stored in the information storage area 130 (S112).

Subsequently, the token generator 113 determines whether the data set in the cell specified in the process of S112 includes full-width characters, and whether a cell set with data obtained by converting the full-width characters included in the data set in the cell specified in the process of S112 into half-width characters exists in the output table 132 (S113).

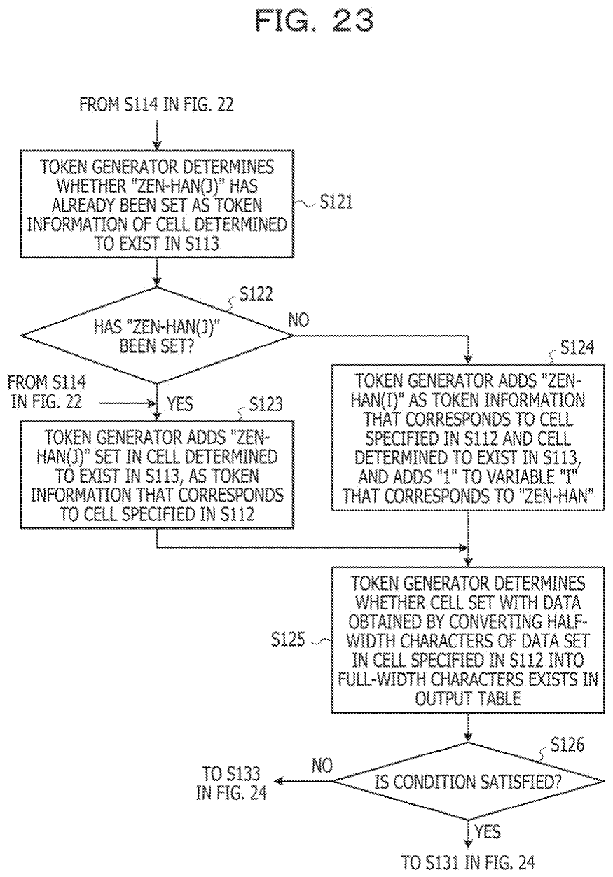

As a result, when it is determined that the data set in the cell specified in the process of S112 includes full-width characters, and a cell set with data obtained by converting the full-width characters included in the data set in the cell specified in the process of S112 into half-width characters exists in the output table 132 (YES in S114), the token generator 113 determines whether “ZEN-HAN(j)” has already been set as the token information 133 of the cell determined to exist in the process of S113 (S121), as illustrated in FIG. 23. The “ZEN-HAN(j)” is the token information 133 added in a process of S123 that has already been performed.

Then, when it is determined that “ZEN-HAN(j)” has already been set as the token information 133 of the cell determined to exist in the process of S113 (YES in S122), the token generator 113 adds “ZEN-HAN(j)” set in the cell determined to exist in the process of S113, as the token information 133 that corresponds to the cell specified in the process of S112 (S123).

Meanwhile, the token generator 113 identically performs the process of S123 even when it is determined that the data set in the cell specified in the process of S112 does not include full-width characters, or a cell set with data obtained by converting the full-width characters included in the data set in the cell specified in the process of S112 into half-width characters does not exist in the output table 132 (NO in S114).

Meanwhile, when it is determined that “ZEN-HAN(j)” has not been set as the token information 133 of the cell determined to exist in the process of S113 (NO in S122), the token generator 113 adds “ZEN-HAN(i)” as the token information 133 that corresponds to the cell specified in the process of S112 and the cell determined to exist in the process of S113 (S124). Then, in this case, the token generator 113 adds “1” to the variable “i” that corresponds to “ZEN-HAN” (S124).

Subsequently, the token generator 113 determines whether the data set in the cell specified in the process of S112 includes half-width characters, and whether a cell set with data obtained by converting the half-width characters included in the data set in the cell specified in the process of S112 into full-width characters exists in the output table 132 (S125).

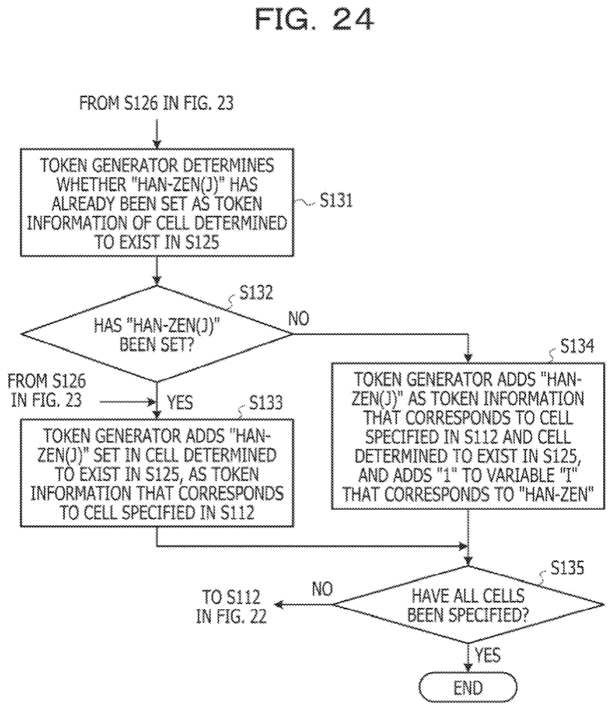

As a result, when it is determined that the data set in the cell specified in the process of S112 includes half-width characters, and a cell set with data obtained by converting the half-width characters included in the data set in the cell specified in the process of S112 into full-width characters exists in the output table 132 (YES in S126), the token generator 113 determines whether “HAN-ZEN(j)” has already been set as the information 133 of the cell determined to exist in the process of S125, as illustrated in FIG. 24 (S131). The “HAN-ZEN(j)” is the token information 133 added in a process of S133 that has already been performed.

Then, when it is determined that “HAN-ZEN(j)” has already been set as the token information 133 of the cell determined to exist in the process of S125 (YES in S132), the token generator 113 adds “HAN-ZEN(j)” set in the cell determined to exist in the process of S125, as the token information 133 that corresponds to the cell specified in the process of S112 (S133).

Meanwhile, the token generator 113 identically performs the process of S133 even when the data set in the cell specified in the process of S112 does not include half-width characters, or a cell set with data obtained by converting the half-width characters included in the data set in the cell specified in the process of S112 into full-width characters does not exist in the output table 132 (NO in S126).

Meanwhile, when it is determined that “HAN-ZEN(j)” has not been set as the token information 133 of the cell determined to exist in the process of S125 (NO in S132), the token generator 113 adds “HAN-ZEN(i)” as the token information 133 that corresponds to the cell specified in the process of S112 and the cell determined to exist in the process of S125 (S134). Then, in this case, the token generator 113 adds “1” to the variable “i” that corresponds to “HAN-ZEN” (S134).

Then, after the process of S133 or S134, the token generator 113 determines whether all of the cells of the input table 131 have been acquired in the process of S112 (S135).

As a result, when it is determined that all of the cells of the input table 131 have not been acquired in the process of S112 (NO in S135), the token generator 113 performs the processes of S112 and subsequent steps again.

Meanwhile, when it is determined that all of the cells of the input table 131 have been acquired in the process of S112 (YES in S135), the token generator 113 ends the fourth token generating process. Hereinafter, a specific example of the fourth token generating process will be described.

<Specific Example of Fourth Token Generating Process>

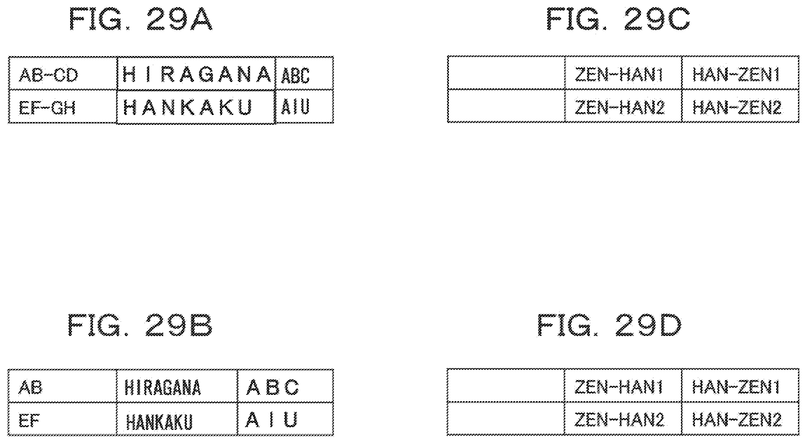

The characters of “HIRAGANA” set in the cell of the first row/the second column of the input table 131 illustrated in FIG. 29A are full-width characters. Further, the characters of “HIRAGANA” set in the cell of the first row/the second column of the output table 132 illustrated in FIG. 29B are half-width characters. Thus, for example, the token generator 113 sets “ZEN-HAN1” in each of the cell of the first row/the second column of the token information 133a illustrated in FIG. 29C and the cell of the first row/the second column of the token information 133b illustrated in FIG. 29D.

Further, the characters of “HANKAKU” set in the cell of the second row/the second column of the input table 131 illustrated in FIG. 29A are full-width characters. Further, the characters of “HANKAKU” set in the cell of the second row/the second column of the output table 132 illustrated in FIG. 29B are half-width characters. Thus, for example, the token generator 113 sets “ZEN-HAN2” in each of the cell of the second row/the second column of the token information 133a illustrated in FIG. 29C and the cell of the second row/the second column of the token information 133b illustrated in FIG. 29D.

Further, the characters of “ABC” set in the cell of the first row/the third column of the input table 131 illustrated in FIG. 29A are half-width characters. Further, the characters of “ABC” set in the cell of the first row/the third column of the output table 132 illustrated in FIG. 29B are full-width characters. Thus, for example, the token generator 113 sets “HAN-ZEN1” in each of the cell of the first row/the third column of the token information 133a illustrated in FIG. 29C and the cell of the first row/the third column of the token information 133b illustrated in FIG. 29D.

Further, the characters of “AIU” set in the cell of the second row/the third column of the input table 131 illustrated in FIG. 29A are half-width characters. Further, the characters of “AIU” set in the cell of the second row/the third column of the output table 132 illustrated in FIG. 29B are full-width characters. Thus, for example, the token generator 113 sets “HAN-ZEN2” in each of the cell of the second row/the third column of the token information 133a illustrated in FIG. 29C and the cell of the second row/the third column of the token information 133b illustrated in FIG. 29D.

Referring back to FIG. 13, after the fourth token generating process is completed, the token generator 113 determines whether a cell set with data that is not set in the cells of the output table 132 stored in the information storage area 130 exists in the cells of the input table 131 stored in the information storage area 130 (S23).

As a result, it is determined that a cell set with data that is not set in the cells of the output table 132 stored in the information storage area 130 exists in the cells of the input table 131 stored in the information storage area 130 (YES in S24), the token generator 113 adds “DROP” as the token information 133 that corresponds to the cell determined to exist in the process of S23 (S25).

That is, in this case, the token generator 113 adds “DROP” which is the token information 133 indicating that a cell set with data that is not set in the cells of the output table 132 exists in the cells of the input table 131, as the token information 133 that corresponds to the cell determined to exist in the process of S23.

Meanwhile, it is determined that a cell set with data that is not set in the cells of the output table 132 stored in the information storage area 130 does not exist in the cells of the input table 131 stored in the information storage area 130 (NO of S24), the token generator 113 does not perform the process of S25.

<Program Generating Process>

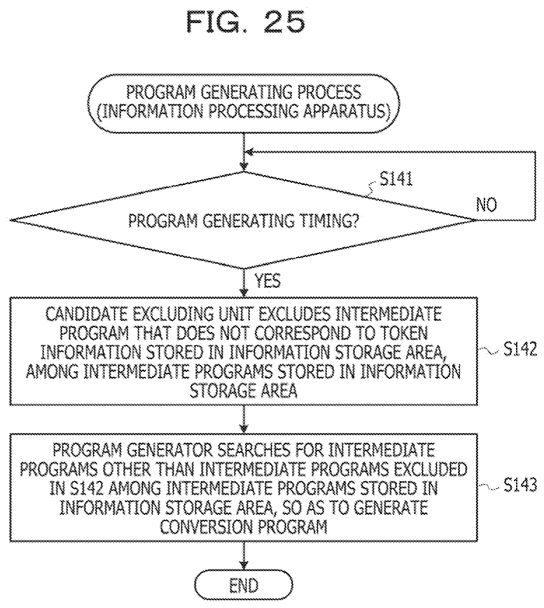

Next, in the data processing, a process of generating the conversion program (hereinafter, also referred to as a program generating process) will be described. FIG. 25 is a flowchart illustrating the program generating process.

As illustrated in FIG. 25, the candidate excluding unit 114 of the information processing apparatus 1 waits until a program generating timing comes (NO in S141). The program generating timing may be, for example, a timing when the user inputs information for executing the generation of the conversion program through the operation terminal 2.

Then, when the program generating timing comes (YES in S141), the candidate excluding unit 114 excludes an intermediate program that does not correspond to the token information 133 stored in the information storage area 130, among the intermediate programs PG stored in the information storage area 130, from candidates for intermediate programs PG used to generate the conversion program (S142).

Specifically, for example, when “NULL” is not generated as the token information 133 that corresponds to the input table 131 or the output table 132, the candidate excluding unit 114 excludes, for example, each intermediate program PG executed when a cell set with no data exists in the input table 131 or the output table 132, from candidates for intermediate programs PG used to generate the conversion program.

Further, for example, when “DROP” is not generated as the token information 133 that corresponds to the input table 131, the candidate excluding unit 114 excludes, for example, each intermediate program PG for deleting a column of cells in the input table 131, from candidates of intermediate programs PG used to generate the conversion program.

Further, for example, when multiple “SAMEs” having the same value of the variable “i” are not generated as the token information 133 that corresponds to the input table 131, the candidate excluding unit 114 excludes, for example, each intermediate program PG for generating the output table 132 such that data set in cells of multiple columns in the input table 131 are set in cells of one column, from candidates for intermediate programs PG used to generate the conversion program.

Further, for example, when multiple “SAMEs” having the same value of the variable “i” are not generated as the token information 133 that corresponds to the output table 132, the candidate excluding unit 114 excludes, for example, each intermediate program PG for generating the output table 132 such that data set in cells of one column in the input table 131 are set in cells of multiple columns, from candidates for intermediate programs PG used to generate the conversion program.

Further, for example, when “INCLUDED” and “SHARE” are not generated as the token information 133 that corresponds to the input table 131 and the output table 132, the candidate excluding unit 114 excludes, for example, each intermediate program PG for combining data set in multiple cells of the input table 131 and setting the combined data in the output table 132, from candidates for intermediate programs PG used to generate the conversion program.

Further, for example, when “INCLUDE” and “SHARE” are not generated as the token information 133 that corresponds to the input table 131 and the output table 132, the candidate excluding unit 114 excludes, for example, each intermediate program PG for dividing data set in the input table 131 and setting the divided data in multiple cells of the output table 132, from candidates for intermediate programs PG used to generate the conversion program.

Further, for example, when there exists a parameter for which token information 133 is not generated in the input table 131 or the output table 132, the candidate excluding unit 114 excludes, for example, the corresponding parameter from a list of parameters (not illustrated) referred to when each intermediate program PG is executed.

Then, the program generator 115 of the information processing apparatus 1 searches for the intermediate programs PG other than the intermediate programs PG excluded in the process of S142 among the intermediate programs PG stored in the information storage area 130, so as to generate the conversion program (S143).

In this way, the information processing apparatus 1 according to the present embodiment generates the token information 133 indicating the characteristics of an associating relation between input data and output data obtained by converting the input data according to a predetermined rule.

Then, when searching for one or more intermediate programs PG used to generate the conversion program for converting the input data into the output data from multiple intermediate programs PG stored in the information storage area 130, the information processing apparatus 1 excludes an intermediate program PG that does not correspond to the generated token information 133, from candidates for the intermediate programs PG used to generate the conversion program.

That is, for example, the information processing apparatus 1 according to the present embodiment specifies, in advance, an intermediate program PG which may be determined not to be selected for the generation of the conversion program, from the associating relation between information set in each cell of the input table 131 and information set in each cell of the output table 132. Then, the information processing apparatus 1 searches for a combination of intermediate programs PG used to generate the conversion program from the intermediate programs PG other than the intermediate programs PG specified in advance among the intermediate programs PG stored in the information storage area 130.

As a result, for example, the information processing apparatus 1 is able to generate the conversion program for converting the input data into the output data in a short time, even when the data sizes of the input data to be converted and the output data in the input table 131 and the output table 132 are large.

According to an aspect of the embodiments, it is possible to generate the conversion program in a short time, even when the data sizes of the input data and the output data are large.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
generating token information that indicates a characteristic of an associating relation between input data and output data obtained by converting the input data according to a predetermined rule; and
when searching for one or more intermediate programs used to generate a conversion program for converting the input data into the output data among multiple intermediate programs stored in a storage, excluding an intermediate program that does not correspond to the token information from candidates of the one or more intermediate programs.

2. The non-transitory computer-readable recording medium according to claim 1, wherein
the input data and the output data are an input table and an output table in a table format, respectively, and
the process further comprises:
performing the generation of the token information for each cell that makes up the input table and the output table.

3. The non-transitory computer-readable recording medium according to claim 2, the process further comprising:
when same data is set in one or more first cells that make up the input table and one or more second cells that make up the output table, generating information that indicates that the same data is set in the one or more first cells and the one or more second cells, as the token information that corresponds to each of the one or more first cells and the one or more second cells.

4. The non-transitory computer-readable recording medium according to claim 2, the process further comprising:
when no data is set in a specific cell that makes up the input table or the output table, generating information that indicates that no data is set in the specific cell, as the token information that corresponds to the specific cell.

5. The non-transitory computer-readable recording medium according to claim 2, the process further comprising:
when data set in a specific cell that makes up the input table is not set in any cell that makes up the output table, generating information that indicates that the data set in the specific cell is not set in any cell that makes up the output table, as the token information that corresponds to the specific cell.

6. The non-transitory computer-readable recording medium according to claim 2, the process further comprising:
when first data set in a first cell that makes up the input table partially includes second data set in a second cell that makes up the output table, generating information that indicates that the first data partially includes the second data, as the token information that corresponds to each of the first cell and the second cell.

7. The non-transitory computer-readable recording medium according to claim 2, the process further comprising:
when first data set in a first cell that makes up the input table is included in a portion of second data set in a second cell that makes up the output table, generating information that indicates that the first data is included in a portion of the second data, as the token information that corresponds to each of the first cell and the second cell.

8. The non-transitory computer-readable recording medium according to claim 2, the process further comprising:
when a portion of first data set in a first cell that makes up the input table is common with a portion of second data set in a second cell that makes up the output table, generating information that indicates that a portion of the first data is common with a portion of the second data, as the token information that corresponds to each of the first cell and the second cell.

9. The non-transitory computer-readable recording medium according to claim 2, the process further comprising:
when a specific cell that makes up the input table includes a parameter that indicates that a plurality of data generated by dividing data set in the specific cell is set in a plurality of cells that make up the output table, respectively, generating information that indicates that the specific cell includes the parameter, as the token information that corresponds to the specific cell.

10. The non-transitory computer-readable recording medium according to claim 2, the process further comprising:
when a specific cell that makes up the output table includes a parameter that indicates that first data set in the specific cell is generated by combining second data set in a plurality of cells that makes up the input table, respectively, generating information that indicates that the specific cell includes the parameter, as the token information that corresponds to the specific cell.

11. The non-transitory computer-readable recording medium according to claim 2, the process further comprising:
when a same character string is set in a first cell that makes up the input table and a second cell that makes up the output table, a first character string set in the first cell is in half-width, and a second character string set in the second cell is in full-width, generating information that indicates that the second character string is generated by converting the first character string into full-width, as the token information that corresponds to each of the first cell and the second cell.

12. The non-transitory computer-readable recording medium according to claim 2, the process further comprising:
when a same character string is set in a first cell that makes up the input table and a second cell that makes up the output table, a first character string set in the first cell is in full-width and a second character string set in the second cell is in half-width, generating information that indicates that the second character string is generated by converting the first character string into half-width, as the token information that corresponds to each of the first cell and the second cell.

13. An information processing apparatus, comprising:
a memory; and
a processor coupled to the memory and the processor configured to:
generate token information that indicates a characteristic of an associating relation between input data and output data obtained by converting the input data according to a predetermined rule; and
when searching for one or more intermediate programs used to generate a conversion program for converting the input data into the output data among multiple intermediate programs stored in a storage, exclude an intermediate program that does not correspond to the token information from candidates of the one or more intermediate programs.

14. The information processing apparatus according to claim 13, wherein
the input data and the output data are an input table and an output table in a table format, respectively, and
the processor is further configured to:
perform the generation of the token information for each cell that makes up the input table and the output table.

15. A data processing method, comprising:
generating, by a computer, token information that indicates a characteristic of an associating relation between input data and output data obtained by converting the input data according to a predetermined rule; and
when searching for one or more intermediate programs used to generate a conversion program for converting the input data into the output data among multiple intermediate programs stored in a storage, excluding an intermediate program that does not correspond to the token information from candidates of the one or more intermediate programs.

16. The data processing method according to claim 15, wherein
the input data and the output data are an input table and an output table in a table format, respectively, and
the data processing method further comprises:
performing the generation of the token information for each cell that makes up the input table and the output table.
